(19) United States
(12) Patent Application Publication
(10) Pub. No.: US 2017/0357612 A1
(43) Pub. Date: Dec. 14, 2017

(54) INFORMATION PROCESSING APPARATUS AND MAINTENANCE SYSTEM

(71) Applicant: Fujitsu Limited, Kawasaki-shi (JP)

(72) Inventor: Junichi Takamiya, Kawasaki (JP)

(73) Assignee: Fujitsu Limited, Kawasaki-shi (JP)

(21) Appl. No.: 15/688,302

(22) Filed: Aug. 28, 2017

Related U.S. Application Data
(63) Continuation of application No. PCT/JP2015/056686, filed on Mar. 6, 2015.

(51) Int. Cl. G06F 15/173; H04L 5/20

(52) U.S. Cl. CPC G06F 15/1735; H04L 5/20

(57) ABSTRACT

A disclosed information processing apparatus includes a memory and a processor coupled to the memory. And the processor is configured to detect that a first apparatus is connected to a first network port, change network settings of the information processing apparatus into first network settings for the first network port, upon detecting that the first apparatus is connected to the first network port, and switch transmission paths in the information processing apparatus to enable the first apparatus to communicate using the first network port, upon detecting that the first apparatus is connected to the first network port.

### CROSS-REFERENCE TO RELATED APPLICATIONS

This application is a continuing application, filed under 35 U.S.C. section 111(a), of International Application PCT/JP2015/056686, filed on Mar. 6, 2015, the entire contents of which are incorporated herein by reference.

### FIELD

This invention relates to a technique for maintenance of an information processing apparatus.

### BACKGROUND

There is a case where a server is connected to a network for management (hereinafter, referred to as a management network) in addition to a network used by a user OS (Operating System) (hereinafter, referred to as a work network) operating on the server. The management network is a dedicated network for accessing a management controller in the server. Since the work network and the management network are physically separated, user data on the OS cannot be accessed from the management network.

When a maintenance worker carries out a maintenance work on such a server, the maintenance worker refers to logs or the like stored in the server in order to check operation of the server. However, if the server cannot be directly controlled due to a security problem, a maintenance terminal is connected to the server via the management network to access the logs stored in the server.

According to TCP/IPv4 (Transmission Control Protocol/Internet Protocol version 4), when a maintenance terminal is connected to a server via a management network, the server and the terminal have to belong to the same network. In order to make both belong to the same network, as shown in FIG. 1, for example, network settings of the terminal may be changed according to network settings of the server. In the example of FIG. 1, an IP address of the terminal is changed from “128.10.20.30” to “192.168.1.11”, and a subnet mask of the terminal is changed from “255.255.0.0” to “255.255.255.0”. Moreover, as shown in FIG. 2, for example, the network settings of the server may be changed according to the network settings of the terminal. In the example of FIG. 2, an IP address of the server is changed from “192.168.1.10” to “128.10.20.31”, and a subnet mask of the server is changed from “255.255.255.0” to “255.255.0.0”.

However, there is a case where the maintenance worker is not able to obtain the network settings of the server (for example, the user does not want to disclose the network settings). In this case, since the maintenance worker is not able to match the network settings, the maintenance worker cannot enable the terminal to access the logs in the server, and the maintenance worker cannot carry out the maintenance work. In a prior art relating to a connection between a server and a terminal, such a problem has not been noticed. In other words, there is no technique for changing network settings of a server into network settings for a terminal when the terminal is connected to a server.

Patent Document 1: Japanese Laid-open Patent Publication No. 8-110879

### SUMMARY

An information processing apparatus related to this invention includes a memory and a processor coupled to the memory. And the processor is configured to: detect that a first apparatus is connected to a first network port; change network settings of the information processing apparatus into first network settings for the first network port, upon detecting that the first apparatus is connected to the first network port; and switch transmission paths in the information processing apparatus to enable the first apparatus to communicate using the first network port, upon detecting that the first apparatus is connected to the first network port.

In one aspect, it becomes possible to change network settings of a server into network settings for a terminal when the terminal is connected to a server.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram for explaining change of network settings;

FIG. 2 is a diagram for explaining change of the network settings;

FIG. 3 is a diagram depicting a system outline of a first embodiment;

FIG. 4 is a diagram depicting an example of data that is stored in a data storage unit;

FIG. 5 is a functional block diagram of a maintenance terminal;

FIG. 6 is a diagram for explaining an outline of the first embodiment;

FIG. 7 is a diagram depicting a processing flow of processing that is executed by a server in the first embodiment;

FIG. 8 is a diagram depicting a processing flow of save processing;

FIG. 9 is a diagram depicting a processing flow of settings switch processing in the first embodiment;

FIG. 10 is a diagram depicting the processing flow of processing executed by the server in the first embodiment;

FIG. 11 is a diagram depicting the processing flow of processing executed by the server in the first embodiment;

FIG. 12 is a diagram depicting a system outline of a second embodiment;

FIG. 13 is a diagram depicting a processing flow of processing executed by a server in the second embodiment;

FIG. 14 is a diagram depicting the processing flow of processing executed by the server in the second embodiment;

FIG. 15 is a diagram depicting the processing flow of processing executed by the server in the second embodiment;

FIG. 16 is a diagram depicting a processing flow of processing executed by the server in a third embodiment;

FIG. 17 is a diagram depicting a processing flow of processing executed by a maintenance terminal in the third embodiment;

FIG. 18 is a diagram depicting a system outline of a fourth embodiment;

FIG. 19 is a diagram depicting a processing flow of processing executed by a server in the fourth embodiment;

FIG. 20 is a diagram depicting the processing flow of processing executed by the server in the fourth embodiment;

FIG. 21 is a diagram for explaining an outline of a fifth embodiment;

FIG. 22 is a diagram depicting a processing flow of processing executed by a server in the fifth embodiment;

FIG. 23 is a diagram depicting a processing flow of settings switch processing in the fifth embodiment;

FIG. 24 is a diagram depicting the processing flow of processing executed by the server in the fifth embodiment; and

FIG. 25 is a functional block diagram of a computer.

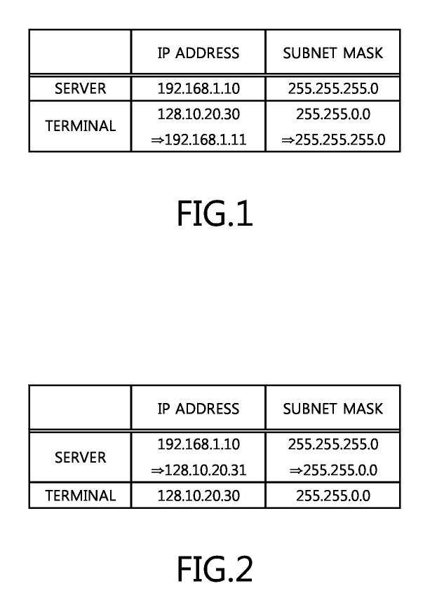

### DESCRIPTION OF EMBODIMENTS

### Embodiment 1

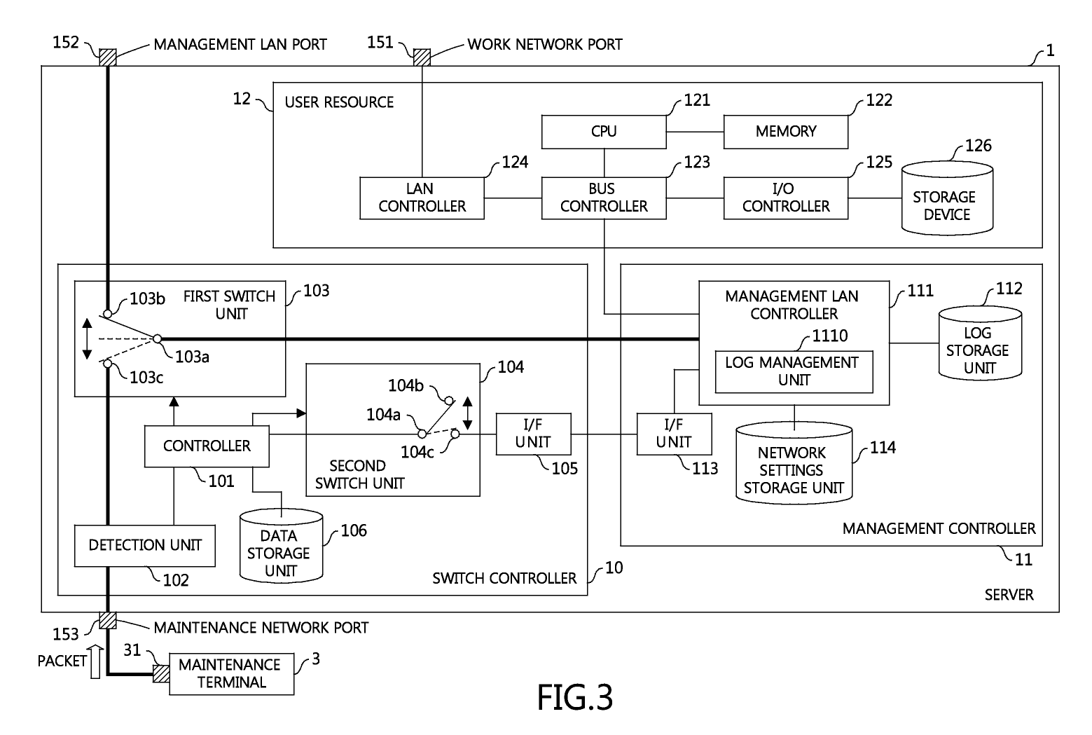

FIG. 3 illustrates a system outline in this embodiment. Server 1 has a work network port 151 which is a network port connected to a work network, a management LAN port 152 which is a network port connected to a management LAN (Local Area Network), and a maintenance network port 153 which is a network port enables a maintenance terminal 3 to connect the server 1. The maintenance terminal 3 is connected to the maintenance network port 153 via a LAN cable or the like.

The server 1 has a switch controller 10 which is, for example, an NIC (Network Interface Card), a management controller 11, and a user resource 12 which is a resource for a user of the server 1.

The switch controller 10 has a controller 101, a detection unit 102, a first switch unit 103, a second switch unit 104, an I/F unit 105, and a data storage unit 106.

The controller 101 executes processing such as controlling the first switch unit 103 and the second switch unit 104 or the like. The detection unit 102 executes processing for detecting that the maintenance terminal 3 is connected to the maintenance network port 153 or the like.

The first switch unit 103 is a switch that switches transmission paths. Specifically, the first switch unit 103 switches transmission paths among a transmission path that connects the management LAN port 152 and the management controller 11 (hereinafter, referred to as a first transmission path), a transmission path that connects the maintenance network port 153 and the management controller 11 (hereinafter, referred to as a second transmission path) and a state in which both transmission paths are broken. In the case of generating the first transmission path, the first switch unit 103 connects the connection point 103a and the connection point 103b. In the case of generating the second transmission path, the first switch unit 103 connects the connection point 103a and the connection point 103c. When breaking both transmission paths, the first switch unit 103 does not connect the connection point 103a to any of the connection points 103b and 103c.

The second switch unit 104 is a switch that generates and breaks a transmission path between the controller 101 and the I/F unit 105. Specifically, the second switch unit 104 connects the connection point 104a and the connection point 104c when connecting the controller 101 and the I/F unit 105 with a transmission path. When the controller 101 and the I/F unit 105 are not connected with a transmission path, the second switch unit 104 connects the connection point 104a and the connection point 104b. The I/F unit 105 is an interface for connecting to the management controller 11.

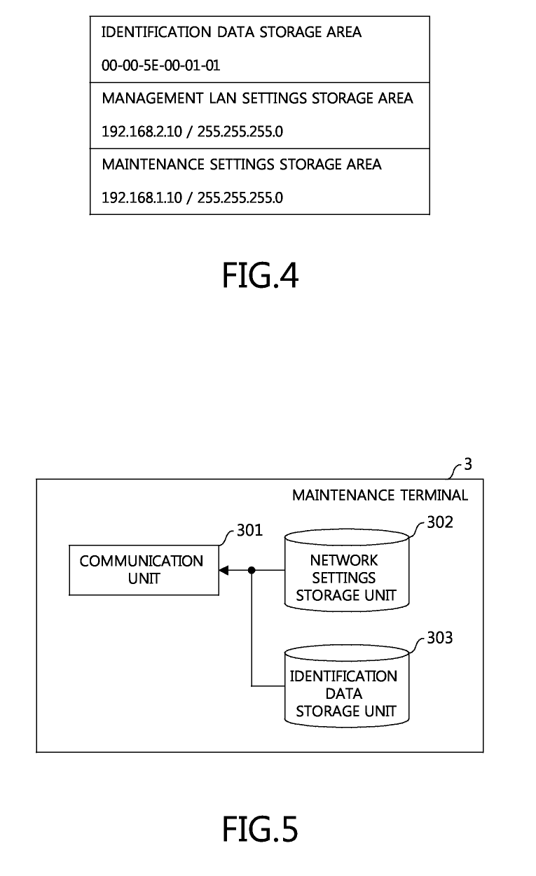

FIG. 4 illustrates an example of data stored in the data storage unit 106. The data storage unit 106 includes an identification data storage area, a management LAN settings storage area, and a maintenance settings storage area. In the identification data storage area, identification data is stored in advance. The management LAN settings storage area is an area for saving management LAN settings. In the maintenance settings storage area, maintenance settings are stored in advance. The identification data is data used when the maintenance terminal 3 accesses the server 1. The management LAN settings are the original network settings of the server 1, and in this embodiment, the network settings include an IP address and a subnet mask. The maintenance settings are network settings used when the maintenance terminal 3 is connected to the server 1. As well as the management LAN settings, the maintenance settings include the IP address and the subnet mask. In this way, by preparing the maintenance settings in advance, even if acquisition of the original network settings of the server 1 is restricted, the maintenance terminal 3 becomes accessible to the data in the server 1.

Returning to the explanation of FIG. 3, the management controller 11 has a management LAN controller 111 having a log management unit 1110, a log storage unit 112, an I/F unit 113, and a network settings storage unit 114.

The log management unit 1110 executes processing for managing a log stored in the log storage unit 112. In the log storage unit 112, logs (for example, operation log) regarding the server 1 are stored. The I/F unit 113 is an interface for connecting with the switch controller 10. The network settings storage unit 114 stores network settings of the server 1.

The user resource 12 includes a CPU 121, a memory 122, a bus controller 123, a LAN controller 124, an I/O controller 125, and a storage device 126. The OS program and the application program of the server 1 are stored in the storage device 126, loaded in the memory 122, and executed by the CPU 121. Since the user resource 12 is the same as the resource used for a normal computer, a detailed explanation will be omitted here.

FIG. 5 shows a functional block diagram of maintenance terminal 3. The maintenance terminal 3 has a communication unit 301, a network settings storage unit 302, an identification data storage unit 303, and a port 31. The communication unit 301 executes processing for transmitting data to the server 1 and processing for receiving data from the server 1. In the network settings storage unit 302, maintenance settings (IP address and subnet mask in the present embodiment) are stored in advance. A network represented by the network settings stored in the network settings storage unit 302 of the maintenance terminal 3 is the same as a network represented by the network settings stored in the maintenance settings storage area. In the identification data storage unit 303, identification data to be used when the maintenance terminal 3 accesses the server 1 is stored in advance.

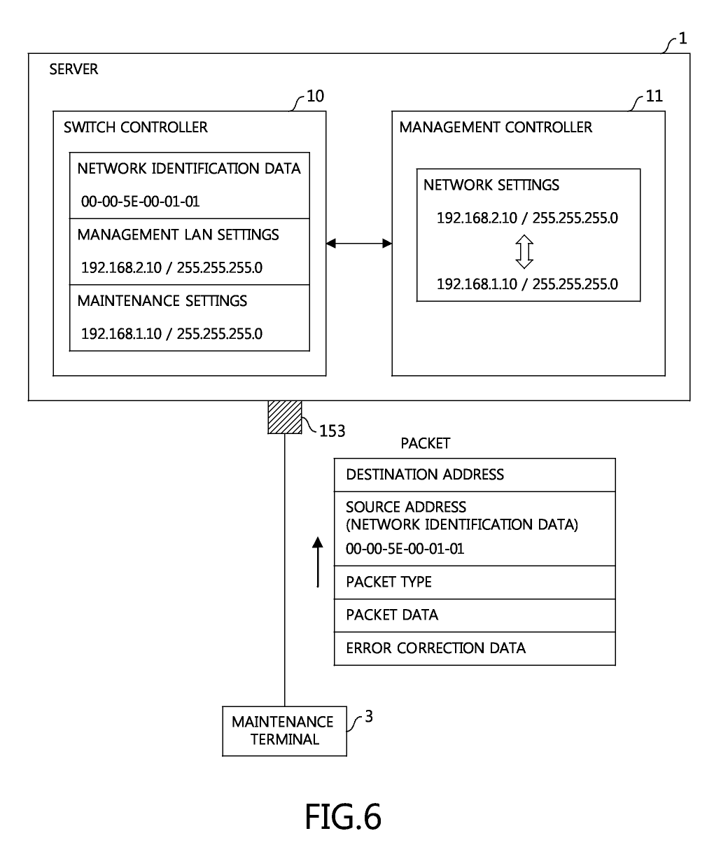

Next, an outline of this embodiment will be explained with reference to FIG. 6.

First, the maintenance terminal 3 connected to the maintenance network port 153 of the server 1 transmits network identification data (00-00-5E-00-01-01) and network settings (192.168.1.10/255.255.255.0) to the server 1. When the network identification data included in the packet is the same as network identification data (00-00-5E-00-01-01) registered in advance in the switch controller 10, the switch controller 10 in the server 1 connects the maintenance network port 153 and the management controller 11 with a transmission path.

However, before access of the maintenance terminal 3 is started, the switch controller 10 saves network settings (192.168.2.10/255.255.255.0) stored in the network settings storage unit 114 of the management controller 11 to an area to which the maintenance terminal 3 is not accessible. Further, the switch controller 10 changes network settings stored in the network settings storage unit 114 of the management controller 11 from the management LAN settings (192.168.2.10/255.255.255.0) to the maintenance settings (192.168.1.10/255.255.255.0).

Then, the network settings (192.168.1.10/255.255.255.0) stored in the network settings storage unit 114 of the management controller 11 coincide with the network settings (192.168.1.10/255.255.255.0) included in the packet transmitted by the maintenance terminal 3. As a result, the maintenance terminal 3 is able to obtain logs stored in the log storage unit 112 from the management controller 11. Further, when the connection of the maintenance terminal 3 is terminated, normal operation is restarted by storing the saved network settings again in the network settings storage unit 114 of the management controller 11.

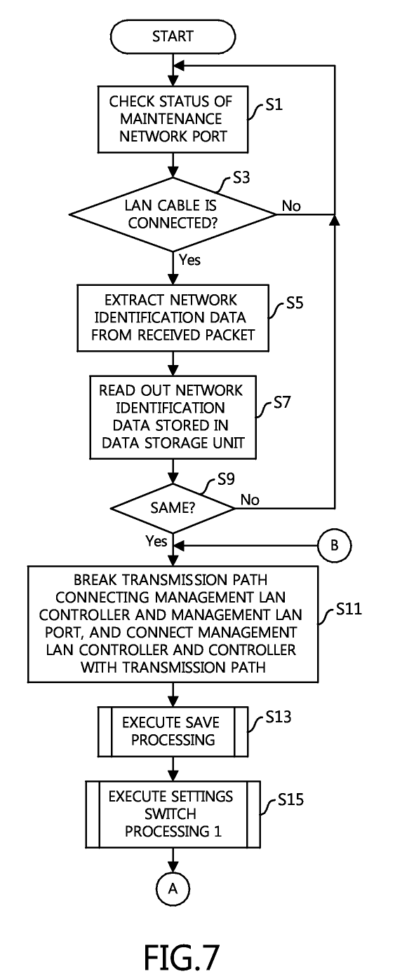

Next, with reference to FIGS. 7 to 11, this embodiment will be explained in more detail. First, the processing when the maintenance terminal 3 is connected to the server 1 will be explained.

First, the detection unit 102 checks status of the maintenance network port 153 (FIG. 7: step S1), and determines whether a LAN cable is connected to the maintenance network port 153 (in other words, linked up) (step S3).

When the LAN cable is not connected to the maintenance network port 153 (step S3: No route), the detection unit 102 waits for a predetermined time and the processing returns to step S1. On the other hand, when the LAN cable is connected to the maintenance network port 153 (step S3: Yes route), the detection unit 102 extracts network identification data from the packet received via the LAN cable (step S5). In this embodiment, the network identification data is a virtual MAC (Media Access Control) address and is stored in a field of the source MAC address in the packet.

The detection unit 102 outputs to the controller 101 a first obtaining request to obtain network identification data. In response to this, the controller 101 reads out network identification data from the identification data storage area in the data storage unit 106 (step S7), and notifies the detection unit 102.

The detection unit 102 determines whether the network identification data extracted from the packet in step S5 matches the network identification data read out from the identification data storage area in step S7 (step S9).

When the network identification data extracted from the packet in step S5 does not match the network identification data read out from the identification data storage area in step S7 (step S9: No route), the received packet is discarded. And the processing returns to step S1.

On the other hand, when the network identification data extracted from the packet in step S5 coincides with the network identification data read out from the identification data storage area in step S7 (step S9: Yes route), the detection unit 102 notifies the controller 101 that the network identification data matched.

The controller 101 outputs a first switching instruction to the first switch unit 103 and the second switch unit 104. In response to this, the first switch unit 103 breaks the transmission path connecting the management LAN controller 111 and the management LAN port 152, and switches to a state in which each of the transmission paths is broken. Further, the second switch unit 104 connects the connection point 104a and the connection point 104c to connect the management LAN controller 111 and the controller 101 with a transmission path (step S11).

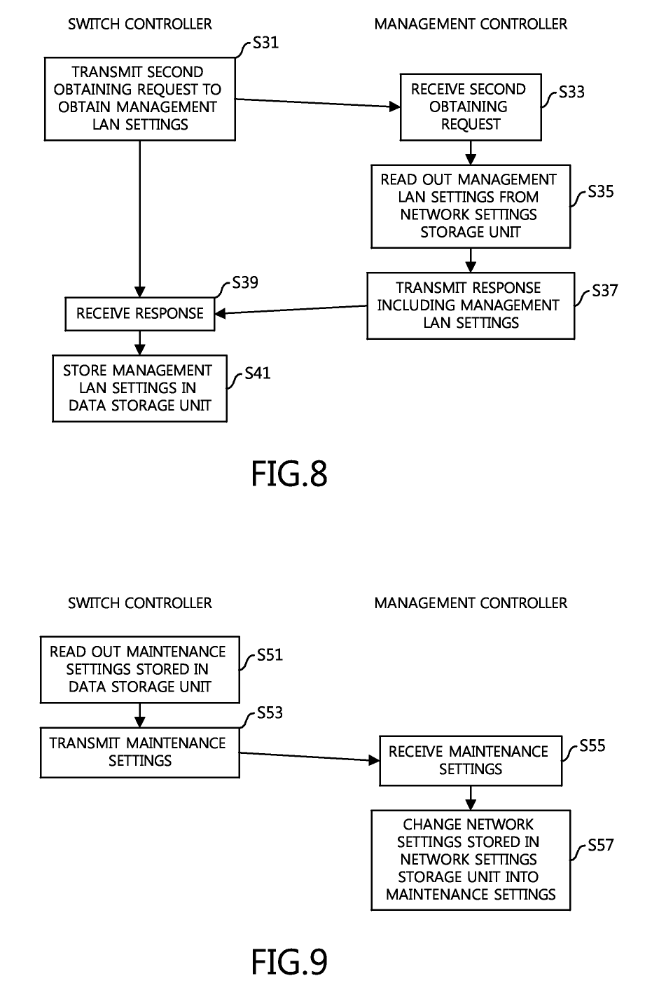

The controller 101 executes save processing (step S13). The save processing will be explained with reference to FIG. 8.

First, the controller 101 in the switch controller 10 transmits a second obtaining request to obtain the management LAN settings to the management LAN controller 111 in the management controller 11 (FIG. 8: step S31). Here, the second obtaining request is transmitted via the transmission path that connects the controller 101 and the management LAN controller 111.

The management LAN controller 111 in the management controller 11 receives the second obtaining request from the controller 101 (step S33). Then, the management LAN controller 111 reads out the management LAN settings from the network settings storage unit 114 (step S35), and transmits a response including the read out management LAN settings to the controller 101 (step S37). Here, the response is transmitted via a transmission path that connects the controller 101 and the management LAN controller 111.

The controller 101 receives a response from the management LAN controller 111 (step S39), and stores the management LAN settings included in the response in the management LAN settings storage area of the data storage unit 106 (step S41). Then, the processing returns to the calling-source processing.

By executing the aforementioned processing, it becomes possible to prevent the management LAN settings from being lost by changing the network settings. Moreover, since the data storage unit 106 is in a location to which the maintenance terminal 3 is not accessible, even if access to the management controller 11 is allowed, the management LAN settings will not be leaked.

Returning to the explanation of FIG. 7, the controller 101 executes settings switch processing in the first embodiment (step S15). The settings switch processing will be explained with reference to FIG. 9.

First, the controller 101 in the switch controller 10 reads out the maintenance settings stored in the maintenance settings storage area of the data storage unit 106 (FIG. 9: step S51). Then, the controller 101 transmits the maintenance settings read out in step S51 to the management LAN controller 111 (step S53). Here, the maintenance settings are transmitted via a transmission path that connects the controller 101 and the management LAN controller 111.

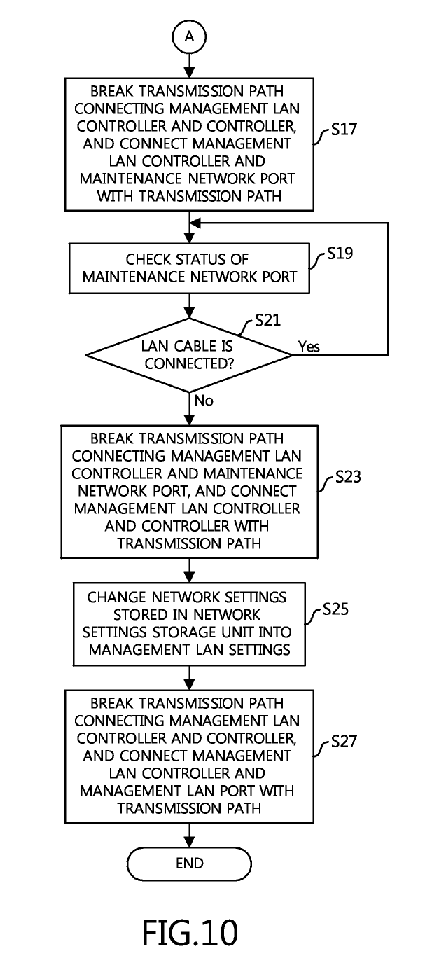

The management LAN controller 111 in the management controller 11 receives the maintenance settings from the controller 101 (step S55). Then, the management LAN controller 111 changes the network settings (in this case, the management LAN settings) stored in the network settings storage unit 114 to the maintenance settings received in step S55 (step S57). Then, the processing returns to the calling-source processing, and the processing shifts to step S17 of FIG. 10 via terminal A.

By executing the aforementioned processing, the maintenance terminal 3 is permitted to access the management controller 11.

Shifting to the explanation of FIG. 10, the controller 101 outputs a second switching instruction to the first switch unit 103 and the second switch unit 104. In response to this, the second switch unit 104 breaks the transmission path that connects the management LAN controller 111 and the controller 101, by connecting the connection point 104a and the connection point 104b. In addition, the first switch unit 103 connects the management LAN controller 111 and the maintenance network port 153 with a transmission path, by connecting the connection point 103a and the connection point 103c (step S17).

Here, the maintenance terminal 3 accesses the management controller 11 and obtains logs from the log storage unit 112 via the log management unit 1110. The processing here will be explained later.

The detection unit 102 checks status of the maintenance network port 153 (step S19), and determines whether a LAN cable is connected to the maintenance network port 153 (step S21).

When the LAN cable is connected to the maintenance network port 153 (step S21: Yes route), the processing returns to step S19. On the other hand, when the LAN cable is not connected to the maintenance network port 153 (step S21: No route), the detection unit 102 notifies the controller 101 that the LAN cable is not connected to the maintenance network port 153.

The controller 101 outputs a third switching instruction to the first switch unit 103 and the second switch unit 104. In response to this, the first switch unit 103 breaks the transmission path that connects the management LAN controller 111 and the maintenance network port 153, and switches to a state in which each of the transmission paths is broken. Further, the second switch unit 104 connects the connection point 104a and the connection point 104c to connect the management LAN controller 111 and the controller 101 with a transmission path (step S23).

The controller 101 changes the network settings stored in the network settings storage unit 114 (in this case, settings for maintenance) into the management LAN settings saved in the management LAN settings storage area of the data storage unit 106 (step S25). Specifically, the controller 101 transmits the management LAN settings saved in the management LAN settings storage area of the data storage unit 106 to the management controller 11. The management LAN controller 111 in the management controller 11 changes the network settings stored in the network settings storage unit 114 into the received management LAN settings. In step S25, the management LAN settings are transmitted via the transmission path that connects the controller 101 and the management LAN controller 111.

The controller 101 outputs a fourth switching instruction to the first switch unit 103 and the second switch unit 104. In response to this, the second switch unit 104 breaks the transmission path that connects the management LAN controller 111 and the controller 101, by connecting the connection point 104a and the connection point 104b. In addition, the first switch unit 103 connects the management LAN controller 111 and the management LAN port 152 with a transmission path, by connecting the connection point 103a and the connection point 103b (step S27). Then, the processing ends.

By executing the aforementioned processing, even if the maintenance staff is not able to obtain the original network settings (in this case, the management LAN settings) in advance, it becomes possible to view the logs of the server 1 and carry out the maintenance work. Moreover, since the change of the network settings is automatically performed, the maintenance worker is able to start maintenance work without particular self-consciousness. Moreover, since the network settings are automatically restored to the original after the maintenance work is finished, it is possible to prevent a maintenance worker from returning to the incorrect network settings.

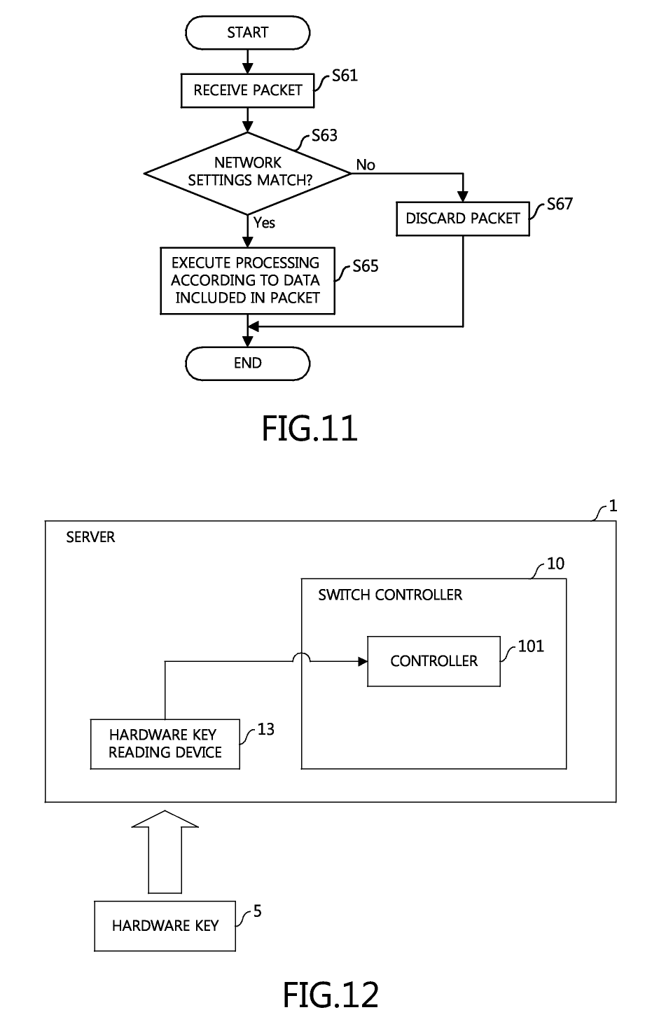

Next, with reference to FIG. 11, processing executed by the management controller 11 that has received a packet from the maintenance terminal 3 will be explained.

First, the detection unit 102 in the switch controller 10 receives a packet (FIG. 11: step S61). The detection unit 102 outputs the received packet to the management controller 11 via the transmission path generated in step S17.

The management controller 11 determines whether the network settings included in the received packet match the network settings stored in the network settings storage unit 114 (step S63).

When the network settings included in the received packet match the network settings stored in the network settings storage unit 114 (step S63: Yes route), the management LAN controller 111 executes processing according to data included in the received packet (Step S65). Then, the processing ends. For example, when the packet is a log request packet requesting log acquisition, the log management unit 1110 reads the corresponding log from the log storage unit 112 and transmits it to the maintenance terminal 3 as a response.

On the other hand, if the network settings included in the received packet do not match the network settings stored in the network settings storage unit 114 (step S63: No route), the management LAN controller 111 discards the received packet (Step S67). Then, the processing ends.

By executing the aforementioned processing, it becomes possible to eliminate access from the maintenance terminal 3 which is not entitled to access the management controller 11.

### Embodiment 2

In a second embodiment, a method for enhancing security by using authentication based on a hardware key will be explained.

FIG. 12 illustrates a system outline of the second embodiment. The server 1 has hardware key reading device 13. Since the part other than the hardware key reading device 13 in the server 1 is the same as in the first embodiment, parts other than those used for the explanation will be omitted.

The hardware key reading device 13 obtains information from a hardware key 5 (e.g., a card carrying an IC (Integrated Circuit) chip) which became close to the hardware key reading device 13, and compares the information from the hardware key 5 with information registered in advance in the hardware key reading device 13 to perform authentication. When the authentication is successful, the hardware key reading device 13 notifies the controller 101 in the switch controller 10 that the authentication is successful.

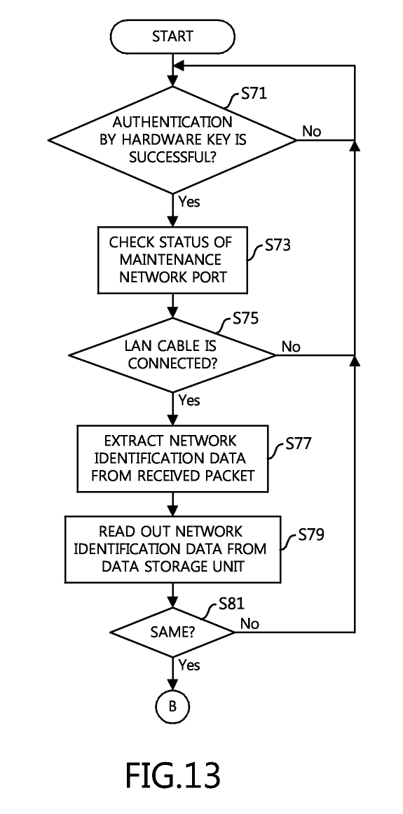

Next, with reference to FIGS. 13 to 15, processing executed by the server 1 in the second embodiment will be explained. First, an example will be explained in which processing after terminal B is executed when authentication by the hardware key 5 is successful and network identification data matches.

First, the detection unit 102 determines whether the authentication by the hardware key 5 is successful (FIG. 13: step S71). Whether or not the authentication by the hardware key 5 is successful is determined from whether or not success of the authentication is notified from the controller 101 notified that the authentication is successful from the hardware key reading device 13.

When the authentication by the hardware key 5 is not successful (step S71: No route), the detection unit 102 waits for a predetermined time, and the processing returns to step S71. On the other hand, when the authentication by the hardware key 5 is successful (step S71: Yes route), the detection unit 102 checks status of the maintenance network port 153 (step S73), and determines whether the LAN cable is connected to the maintenance network port 153 (That is, linked up) (step S75).

When the LAN cable is not connected to the maintenance network port 153 (step S75: No route), the processing returns to step S71. On the other hand, when the LAN cable is connected to the maintenance network port 153 (step S75: Yes route), the detection unit 102 extracts network identification data from the packet received via the LAN cable (step S77). In this embodiment, the network identification data is a virtual MAC address and is stored in a field of the source MAC address in the packet.

The detection unit 102 outputs to the controller 101 a first obtaining request to obtain network identification data. In response to this, the controller 101 reads out network identification data from the identification data storage area in the data storage unit 106 (step S79), and notifies the detection unit 102.

The detection unit 102 determines whether the network identification data extracted from the packet in step S77 matches the network identification data readout from the identification data storage area in step S79 (step S81).

When the network identification data extracted from the packet in step S77 does not match the network identification data read out from the identification data storage area in step S79 (step S81: No route), the received packet is discarded. And the processing returns to step S71.

On the other hand, when the network identification data extracted from the packet in step S77 matches the network identification data read out from the identification data storage area in step S79 (step S81: Yes route), the processing shifts to step S11 of FIG. 7 via terminal B.

Execution of the aforementioned processing makes it possible to enable a double protection method, security becomes enhanced.

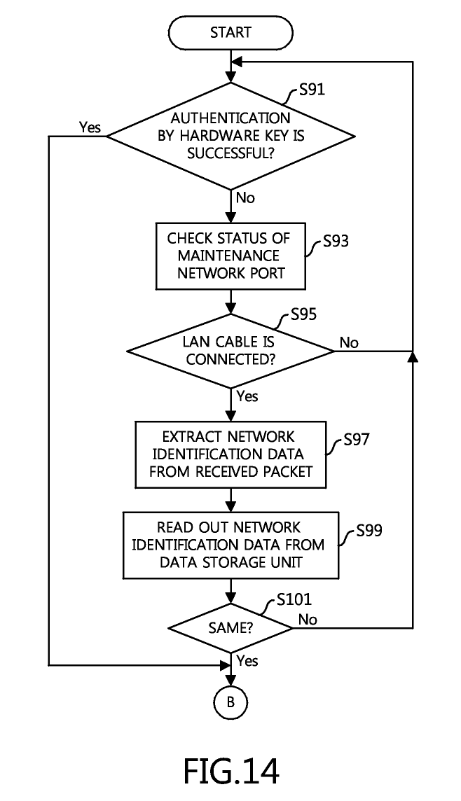

Next, with reference to FIG. 14, an example will be explained in which processing after terminal B is executed when authentication by hardware key 5 is successful or network identification data matches.

First, the detection unit 102 determines whether the authentication by the hardware key 5 is successful (FIG. 14: step S91). Whether or not the authentication by the hardware key 5 is successful is determined from whether or not success of the authentication is notified from the controller 101 notified that the authentication is successful from the hardware key reading device 13.

When the authentication by the hardware key 5 is successful (step S91: Yes route), the processing shifts to step S11 of FIG. 7 via terminal B. On the other hand, when the authentication by the hardware key 5 is not successful (step S91: No route), the detection unit 102 checks status of the maintenance network port 153 (step S93), and determines the LAN cable is connected to the maintenance network port 153 (that is, linked up) (step S95).

If the LAN cable is not connected to the maintenance network port 153 (step S95: No route), the processing returns to step S91. On the other hand, when the LAN cable is connected to the maintenance network port 153 (step S95: Yes route), the detection unit 102 extracts network identification data from the packet received via the LAN cable (step S97).

The detection unit 102 outputs to the controller 101 a first obtaining request to obtain network identification data. In response to this, the controller 101 reads out network identification data from the identification data storage area in the data storage unit 106 (step S99), and notifies the detection unit 102.

The detection unit 102 determines whether the network identification data extracted from the packet in step S97 matches the network identification data readout from the identification data storage area in step S99 (step S101).

When the network identification data extracted from the packet in step S97 does not match the network identification data read out from the identification data storage area in step S99 (step S101: No route), the extracted packet is discarded. And the processing returns to step S91.

On the other hand, when the network identification data extracted from the packet in step S97 matches the network identification data read out from the identification data storage area in step S99 (step S101: Yes route), the processing shifts to step S11 of FIG. 7 via terminal B.

By executing the aforementioned processing, success of the authentication by the hardware key 5 or match of network identification data enhance convenience for a maintenance worker.

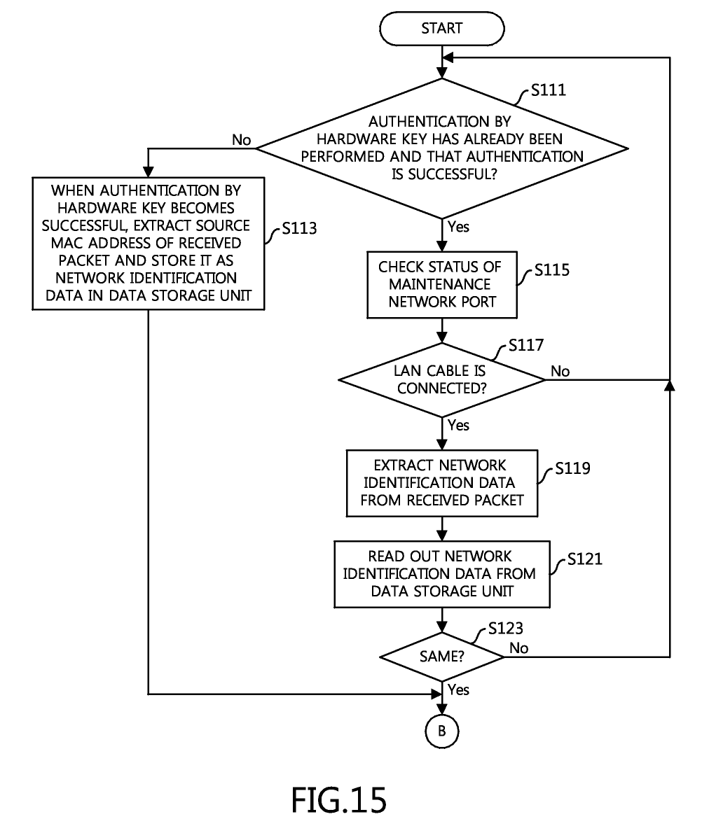

Next, with reference to FIG. 15, an example will be explained in which once authentication by the hardware key 5 succeeds, processing after terminal B is executed after that if only network identification data matches.

First, the detection unit 102 determines whether or not the authentication by the hardware key 5 has already been performed and has been successful (FIG. 15: step S111).

When the authentication by the hardware key 5 has not been successful (step S111: No route), the detection unit 102 executes the following processing. Specifically, the detection unit 102 waits until the authentication by the hardware key 5 succeeds. Then, when the authentication by the hardware key 5 succeeds, the detection unit 102 extracts the source MAC address of the received packet and stores it in the identification data storage area of the data storage unit 106 as network identification data (step S113). The processing shifts to step S11 of FIG. 7 via terminal B.

On the other hand, if the authentication by the hardware key 5 has been successful (step S111: Yes route), the detection unit 102 checks status of the maintenance network port 153 (step S115), and determines whether a LAN cable is connected to the maintenance network port 153 (That is, linked up) (step S117).

If the LAN cable is not connected to the maintenance network port 153 (step S117: No route), the processing returns to step S111. On the other hand, when the LAN cable is connected to the maintenance network port 153 (step S117: Yes route), the detection unit 102 extracts network identification data from the packet received via the LAN cable (step S119). In this embodiment, the network identification data is a virtual MAC address and is stored in a field of the source MAC address in the packet.

The detection unit 102 outputs to the controller 101 a first obtaining request to obtain network identification data. In response to this, the controller 101 reads out network identification data from the identification data storage area in the data storage unit 106 (step S121), and notifies the detection unit 102.

The detection unit 102 determines whether the network identification data extracted from the packet in step S119 matches the network identification data read out from the identification data storage area in step S121 (step S123).

When the network identification data extracted from the packet in step S119 and the network identification data read out from the identification data storage area in step S121 do not match (step S123: No route), the received packet is discarded. And the processing returns to step S111.

On the other hand, when the network identification data extracted from the packet in step S119 matches the network identification data read out from the identification data storage area in step S121 (step S123: Yes route), the processing shifts to step S11 of FIG. 7 via terminal B.

By executing the aforementioned processing, it becomes possible to enhance security and improve convenience for a maintenance worker.

### Embodiment 3

In a third embodiment, a method for enhancing security by not continuing to use the same network identification data will be explained.

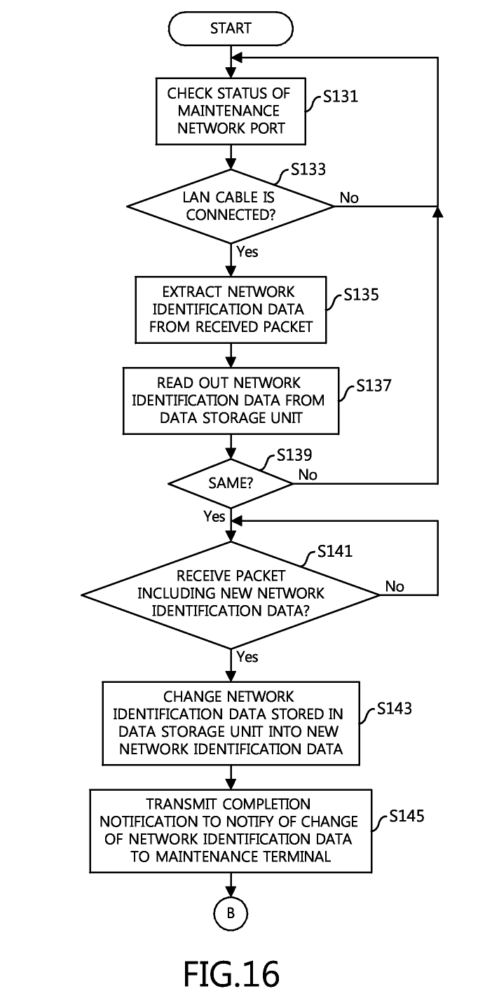

With reference to FIG. 16, processing executed by the server 1 in the third embodiment will be explained. First, the detection unit 102 checks status of the maintenance network port 153 (FIG. 16: step S131), and determines whether a LAN cable is connected to the maintenance network port 153 (that is, linked up) (step S133).

When the LAN cable is not connected to the maintenance network port 153 (step S133: No route), the processing returns to step S131. On the other hand, when the LAN cable is connected to the maintenance network port 153 (step S133: Yes route), the detection unit 102 extracts network identification data from the packet received via the LAN cable (step S135). In this embodiment, the network identification data is a virtual MAC address and is stored in a field of the source MAC address in the packet.

The detection unit 102 outputs to the controller 101 a first obtaining request to obtain network identification data. In response to this, the controller 101 reads out network identification data from the identification data storage area in the data storage unit 106 (step S137), and notifies the detection unit 102.

The detection unit 102 determines whether the network identification data extracted from the packet in step S135 matches the network identification data read out from the identification data storage area in step S137 (step S139).

If the network identification data extracted from the packet in step S135 does not match the network identification data read out from the identification data storage area in step S137 (step S139: No route), the received packet is discarded. And the processing returns to step S131.

On the other hand, when the network identification data extracted from the packet in step S135 matches the network identification data read out from the identification data storage area in step S137 (step S139: Yes route), the detection unit 102 executes the following processing. Specifically, the detection unit 102 determines whether a packet including new network identification data different from the network identification data extracted in step S135 has been received from the maintenance terminal 3 (step S141).

When the packet including the new network identification data is not received from the maintenance terminal 3 (step S141: No route), the detection unit 102 waits for a predetermined time and returns to the processing of step S141. On the other hand, when the packet including the new network identification data is received from the maintenance terminal 3 (step S141: Yes route), the detection unit 102 outputs the new network identification data to the controller 101. In response to this, the controller 101 changes network identification data stored in the identification data storage area of the data storage unit 106 into the new network identification data (step S143). The controller 101 notifies the detection unit 102 that change of network identification data is completed.

The detection unit 102 transmits, to the maintenance terminal 3, a completion notification indicating that network identification data has been changed (step S145). Then the processing shifts to step S11 of FIG. 7 via terminal B.

By executing the aforementioned processing, since network identification data is changed each time the LAN cable is connected, it becomes possible to prevent continuation of using the same network identification data and to improve security.

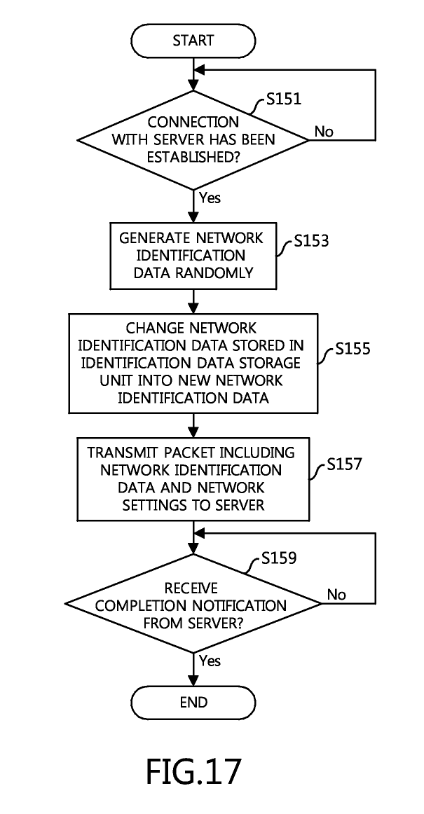

With reference to FIG. 17, processing performed by the maintenance terminal 3 in the third embodiment will be explained. This processing is executed after a packet including network identification data is transmitted for the first time. First, the communication unit 301 of the maintenance terminal 3 determines whether connection with the server 1 has been established by initial transmission of a packet including network identification data (FIG. 17: step S151).

When the connection with the server 1 has not been established (step S151: No route), the communication unit 301 waits for a predetermined time and the processing returns to step S151. On the other hand, when the connection with the server 1 is established (step S151: Yes route), the communication unit 301 randomly generates network identification data (step S153).

The communication unit 301 changes network identification data stored in the identification data storage unit 303 into the network identification data generated in step S153 (step S155). Then, the communication unit 301 transmits, to the server 1, a packet including the network identification data generated in step S153 and network settings stored in the network settings storage unit 302 (step S157).

The communication unit 301 determines whether a completion notification has been received from the server 1 (step S159). When the completion notification has not been received (step S159: No route), the communication unit 301 waits for a predetermined time and the processing returns to step S159. On the other hand, when the completion notification is received (step S159: Yes route), the processing ends.

In this way, since it is possible to generate new network identification data which is difficult to identify each time connection via the LAN cable is made, it becomes possible to enhance security. When the maintenance terminal 3 is changed for some reason, it becomes possible to continue to carry out a maintenance work by taking over network identification data of the new maintenance terminal 3 or restore network identification data registered in the server 1 to initial network identification data.

### Embodiment 4

In a fourth embodiment, an example in which the switch controller 10 and the management controller 11 are provided in separate devices will be explained.

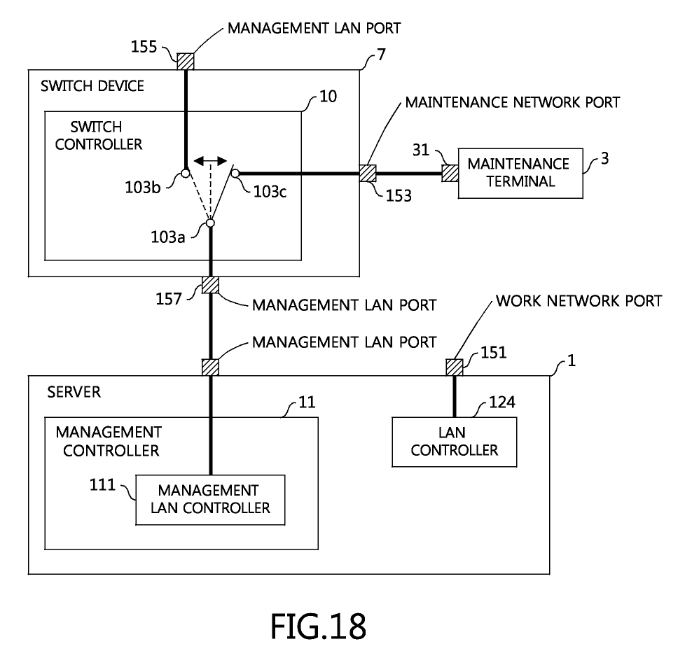

With reference to FIG. 18, a system outline of this embodiment will be explained. The server 1 in the fourth embodiment has the management controller 11 as in the first embodiment, but does not have the switch controller 10. The switch controller 10 is provided in the switch device 7. The switch device 7 has the switch controller 10, the maintenance network port 153, and management LAN ports 155 and 157.

The switch controller 10 can switch transmission paths as in the first embodiment. Specifically, by connecting the connection point 103a and the connection point 103c, the maintenance network port 153 and the management LAN controller 111 are connected by a transmission path. Further, by connecting the connection point 103a and the connection point 103b, the management LAN port 155 and the management LAN controller 111 are connected by a transmission path. As in the first embodiment, a second switch unit 104 is provided between the controller 101 in the switch controller 10 and the management LAN controller 111, and the second switch unit 104 generates and breaks transmission paths between the controller 101 and the management LAN controller 111. However, it is omitted in FIG. 18 in order to make the figure easy to be seen.

It is to be noted that parts other than aforementioned parts of the server 1, the maintenance terminal 3 and the switch controller 10 are the same as those of the first embodiment, and the description is omitted here.

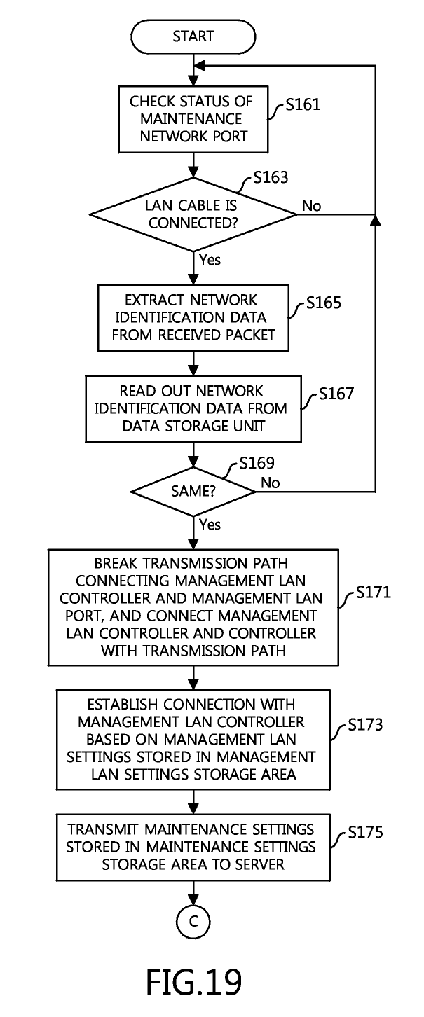

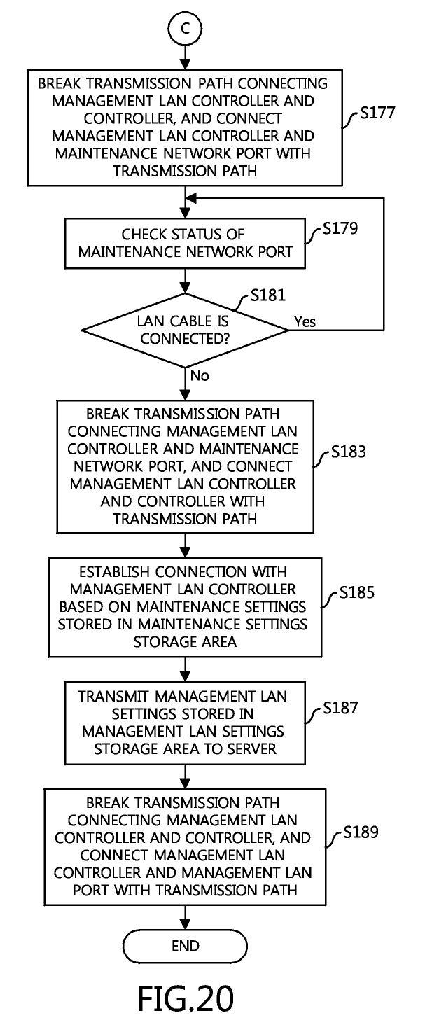

Next, with reference to FIG. 19 and FIG. 20, processing executed by the switch device 7 in the fourth embodiment will be explained.

First, the detection unit 102 checks status of the maintenance network port 153 (FIG. 19: step S161), and determines whether a LAN cable is connected to the maintenance network port 153 (that is, linked up) (step S163).

When the LAN cable is not connected to the maintenance network port 153 (step S163: NO route), the detection unit 102 waits for a predetermined time and the processing returns to step S161. On the other hand, when the LAN cable is connected to the maintenance network port 153 (step S163: Yes route), the detection unit 102 extracts network identification data from the packet received via the LAN cable (step S165). In this embodiment, the network identification data is a virtual MAC address and is stored in a field of the source MAC address in the packet.

The detection unit 102 outputs to the controller 101 a first obtaining request to obtain network identification data. In response to this, the controller 101 reads out network identification data from the identification data storage area of the data storage unit 106 (step S167), and notifies the detection unit 102.

In step S169, the detection unit 102 determines whether the network identification data extracted from the packet in step S165 matches the network identification data read out from the identification data storage area in step S167.

When the network identification data extracted from the packet in step S165 does not match the network identification data read out from the identification data storage area in step S167 (step S169: No route), the received packet is discarded. And the processing returns to S161.

On the other hand, when the network identification data extracted from the packet in step S165 matches the network identification data read out from the identification data storage area in step S167 (step S169: Yes route), the detection unit 102 notifies the controller 101 that the network identification data matched.

The controller 101 outputs a first switching instruction to the first switch unit 103 and the second switch unit 104. In response to this, the first switch unit 103 breaks the transmission path connecting the management LAN controller 111 and the management LAN port 155, and switches to a state in which each of the transmission paths is broken. Further, the second switch unit 104 connects the connection point 104a and the connection point 104c to connect the management LAN controller 111 and the controller 101 with a transmission path (step S171).

The controller 101 establishes a connection with the management LAN controller 111 of the server 1 based on the management LAN settings stored in the management LAN settings storage area in the data storage unit 106 (step S173). It is assumed that the management LAN settings have been obtained from the server 1 in advance.

The controller 101 transmits the maintenance settings stored in the maintenance settings storage area of the data storage unit 106 to the server 1 (step S175). The processing shifts to step S177 of FIG. 20 via terminal C. In response to the processing of step S175, the management LAN controller 111 in the server 1 changes the network settings (management LAN settings in this case) stored in the network settings storage unit 114 into the maintenance settings.

Shifting to explanations for FIG. 20, the controller 101 outputs a second switching instruction to the first switch unit 103 and the second switch unit 104. In response to this, the second switch unit 104 breaks the transmission path connecting the management LAN controller 111 and the controller 101 by connecting the connection point 104a and the connection point 104b. In addition, the first switch unit 103 connects the management LAN controller 111 and the maintenance network port 153 with a transmission path by connecting the connection point 103a and the connection point 103c (step S177).

Here, the maintenance terminal 3 accesses the management controller 11 and obtains logs from the log storage unit 112 by way of the log management unit 1110.

The detection unit 102 checks status of the maintenance network port 153 (step S179), and determines whether a LAN cable is connected to the maintenance network port 153 (step S181).

When the LAN cable is connected to the maintenance network port 153 (step S181: Yes route), the processing returns to step S179. On the other hand, when the LAN cable is not connected to the maintenance network port 153 (step S181: No route), the detection unit 102 notifies the controller 101 that the LAN cable is not connected to the maintenance network port 153.

The controller 101 outputs a third switching instruction to the first switch unit 103 and the second switch unit 104. In response to this, the first switch unit 103 breaks the transmission path connecting the management LAN controller 111 and the maintenance network port 153, and switches to a state in which each of the transmission paths is broken. Further, the second switch unit 104 connects the connection point 104a and the connection point 104c to connect the management LAN controller 111 and the controller 101 with a transmission path (step S183).

The controller 101 establishes a connection with the management LAN controller 111 of the server 1 based on the maintenance settings stored in the maintenance settings storage area of the data storage unit 106 (step S185).

The controller 101 transmits the management LAN settings stored in the management LAN settings storage area of the data storage unit 106 to the server 1 (step S187). In response to the processing of step S187, the management LAN controller 111 in the server 1 changes the network settings (the maintenance settings in this case) stored in the network settings storage unit 114 into the management LAN settings.

The controller 101 outputs a fourth switching instruction to the first switch unit 103 and the second switch unit 104. In response to this, the second switch unit 104 breaks the transmission path connecting the management LAN controller 111 and the controller 101 by connecting the connection point 104a and the connection point 104b. In addition, the first switch unit 103 connects the management LAN controller 111 and the management LAN port 155 with a transmission path by connecting the connection point 103a and the connection point 103b (step S189). Then, the processing ends.

As described above, it becomes possible to flexibly constructing a system suitable for actual conditions such as server placement situation and processing performance, by enabling to realize a system configuration in which the switch controller 10 and the management controller 11 are provided in separate apparatuses.

### Embodiment 5

In the fifth embodiment, an example in which not only an IP address and a subnet mask but also a MAC address is included in the network settings to be saved will be explained.

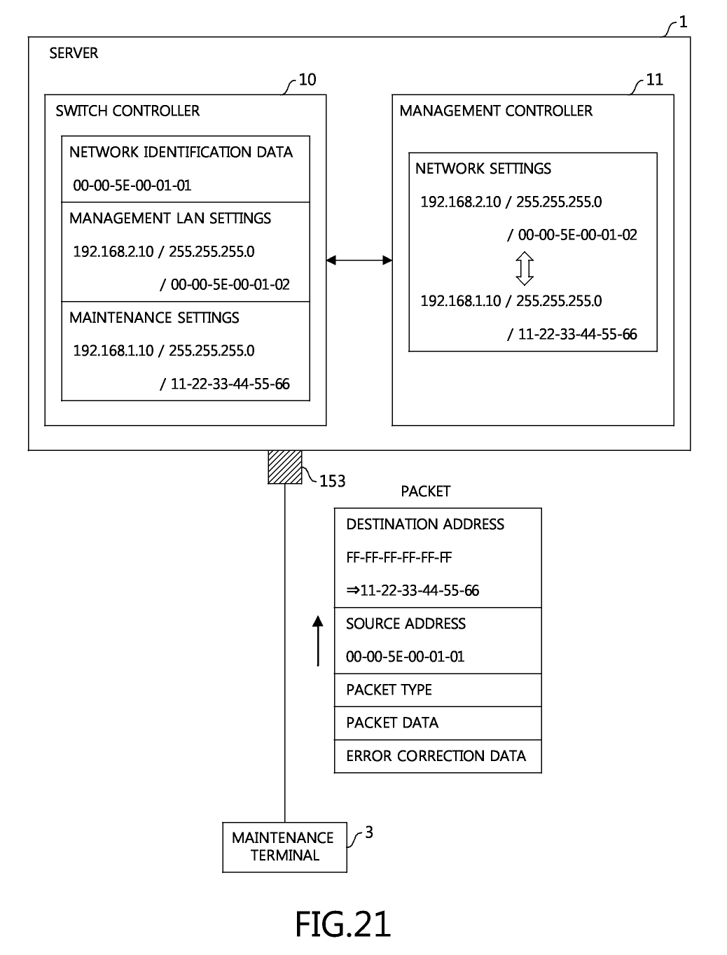

An outline of the fifth embodiment will be explained with reference to FIG. 21.

First, the maintenance terminal 3 connected to the maintenance network port 153 of the server 1 transmits a packet including network identification data (00-00-5E-00-01-01) and network settings (192.168.1.10/255.255.255.0) to the server 1. In this embodiment, ARP (Address Resolution Protocol) packets are transmitted (broadcast in this case) for the first time, and network identification data and network settings are included in the ARP packets.

When the network identification data included in the ARP packet coincides with network identification data (00-00-5E-00-01-01) registered in advance in the switch controller 10, the switch controller 10 in the server 1 connects the maintenance network port 153 and the management controller 11 with a transmission path.

However, before access of the maintenance terminal 3 is started, the switch controller 10 saves the network settings (192.168.2.10/255.255.255.0/00-00-5E-00-01-02) stored in the network settings storage unit 114 of the management controller 11 to an area where the maintenance terminal 3 is not accessible. Further, the switch controller 10 changes the network settings stored in the network settings storage unit 114 of the management controller 11 from the management LAN settings (192.168.2.10/255.255.255.0/00-00-5E-00-01-02) to the maintenance settings (192.168.1.10/255.255.255.0/11-22-33-44-55-66). The maintenance settings include an IP address, a subnet mask and a MAC address randomly generated by the switch controller 10.

Then, the server 1 transmits an ARP response including the MAC address for which the ARP request was generated to maintenance terminal 3. In response to this, the maintenance terminal 3 sets the MAC address included in the ARP response as the destination MAC address, and transmits the packet. Then, the network settings (192.168.1.10/255.255.255.0/11-22-33-44-55-66) stored in the network settings storage unit 114 of the management controller 11 coincide with the network settings (192.168.1.10/255.255.255.0/11-22-33-44-55-66) included in the packet transmitted by the maintenance terminal 3. As a result, the maintenance terminal 3 can obtain logs stored in the log storage unit 112 from the management controller 11. Further, when a connection of the maintenance terminal 3 is terminated, normal operation may be restarted by storing the saved network settings again in the network settings storage unit 114 of the management controller 11.

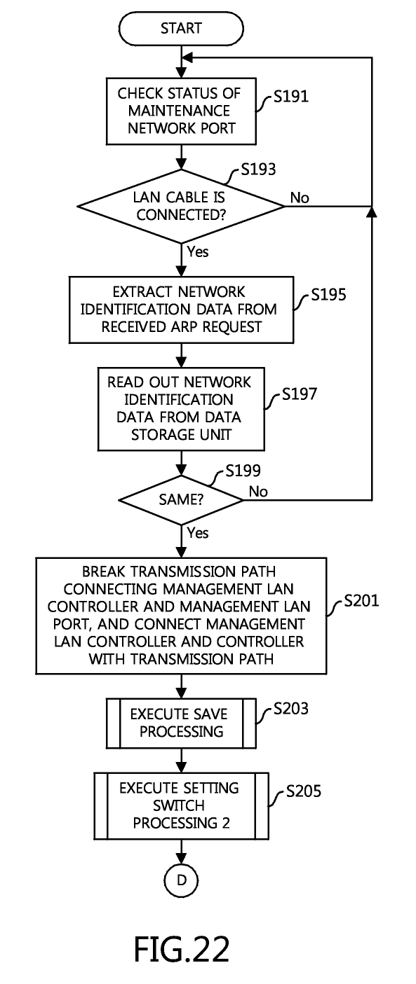

Next, with reference to FIGS. 22 to 24, processing executed by the server 1 in the fifth embodiment will be explained.

First, the detection unit 102 checks status of the maintenance network port 153 (FIG. 22: step S191), and determines whether a LAN cable is connected to the maintenance network port 153 (that is, linked up) (step S193).

When the LAN cable is not connected to the maintenance network port 153 (step S193: No route), the detection unit 102 waits for a predetermined time and the processing returns to step S191. On the other hand, when the LAN cable is connected to the maintenance network port 153 (step S193: Yes route), the detection unit 102 extracts network identification data from the ARP packet received via the LAN cable (step S195). In this embodiment, the network identification data is a virtual MAC address and is stored in a field of the source MAC address in the ARP packet.

The detection unit 102 outputs to the controller 101 a first obtaining request to obtain network identification data. In response to this, the controller 101 reads out network identification data from the identification data storage area in the data storage unit 106 (step S197), and notifies the detection unit 102.

The detection unit 102 determines whether the network identification data extracted from the ARP packet in step S195 matches the network identification data read out from the identification data storage area in step S197 (step S199).

When the network identification data extracted from the ARP packet in step S195 does not match the network identification data read out from the identification data storage area in step S197 (step S199: No route), the received ARP packet is discarded. And the processing returns to step S191.

On the other hand, when the network identification data extracted from the ARP packet in step S195 matches the network identification data read out from the identification data storage area in step S197 (step S199: Yes route), the detection unit 102 determines that the network identification data matched.

The controller 101 outputs a first switching instruction to the first switch unit 103 and the second switch unit 104. In response to this, the first switch unit 103 cuts off the transmission path connecting the management LAN controller 111 and the management LAN port 152, and switches to a state in which each of the transmission paths is broken. Further, the second switch unit 104 connects the connection point 104a and the connection point 104c to connect the management LAN controller 111 and the controller 101 with a transmission path (step S201).

The controller 101 executes save processing (step S203). The save processing is the same as explained with reference to FIG. 8, and explanation is omitted here. However, in the fifth embodiment, the management LAN settings read out in step S35 include a MAC address. Therefore, the management LAN settings stored in step S41 also include the MAC address.

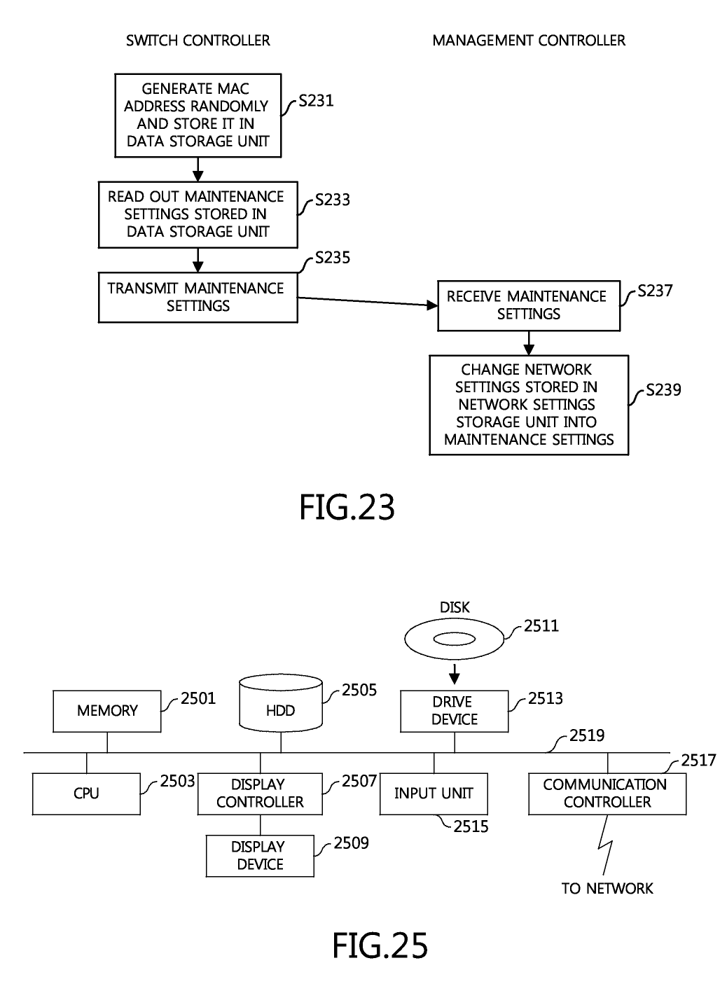

The controller 101 executes settings switch processing in the fifth embodiment (step S205). The settings switch processing will be explained with reference to FIG. 23.

First, the controller 101 in the switch controller 10 randomly generates a MAC address and stores it in the maintenance settings storage area of the data storage unit 106 (FIG. 23: step S231). When the MAC address is already stored in the maintenance settings storage area, the controller 101 overwrites the already-stored MAC address.

The controller 101 reads out the maintenance settings stored in the maintenance settings storage area of the data storage unit 106 (step S233). The maintenance settings that are read out include an IP address, a subnet mask, and the MAC address generated in step S231.

Then, the controller 101 transmits the maintenance settings read out in step S233 to the management LAN controller 111 (step S235). Here, the maintenance settings are transmitted via a transmission path connecting the controller 101 and the management LAN controller 111.

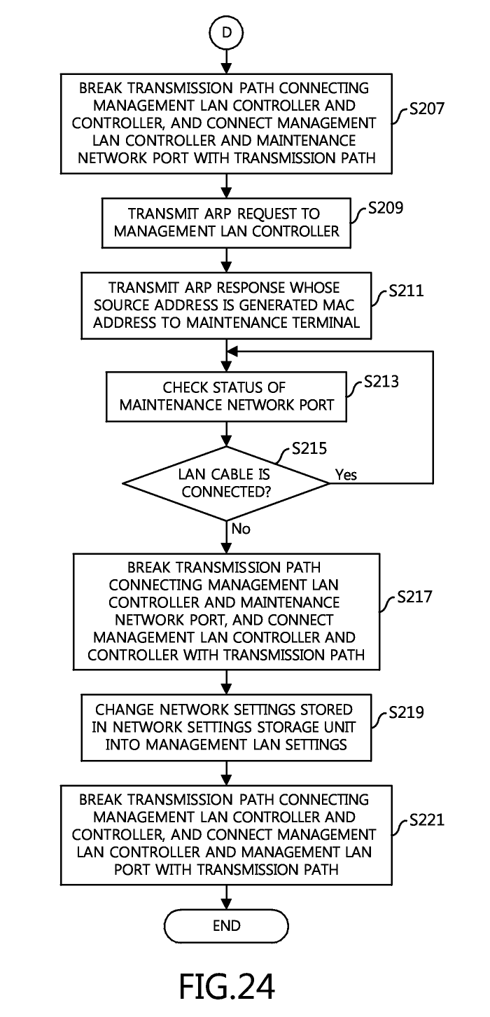

The management LAN controller 111 in the management controller 11 receives the maintenance settings from the controller 101 (step S237). Then, the management LAN controller 111 changes the network settings (the management LAN settings in this case) stored in the network settings storage unit 114 to the maintenance settings received in step S237 (step S239). Then, the processing returns to the calling-source processing, and the processing shifts to step S207 of FIG. 24 via terminal D.

By executing the aforementioned processing, the maintenance terminal 3 becomes permitted to access the management controller 11.

Shifting to the explanation of FIG. 24, the controller 101 outputs a second switching instruction to the first switch unit 103 and the second switch unit 104. In response to this, the second switch unit 104 breaks the transmission path connecting the management LAN controller 111 and the controller 101 by connecting the connection point 104a and the connection point 104b. In addition, the first switch unit 103 connects the management LAN controller 111 and the maintenance network port 153 with a transmission path by connecting the connection point 103a and the connection point 103c (step S207).

The controller 101 transmits an ARP request to the management LAN controller 111 (step S209). In response to this, the management LAN controller 111 transmits an ARP response including the MAC address stored in the network settings storage unit 114 to the controller 101. Then, the controller 101 transmits the ARP response received from the management LAN controller 111 to the maintenance terminal 3 (step S211).

In response to this, the maintenance terminal 3 uses the MAC address included in the ARP response as the destination address of packets to be transmitted to the server 1.

Then, the maintenance terminal 3 accesses the management controller 11 and obtains logs from the log storage unit 112 by way of the log management unit 1110.

The detection unit 102 checks status of the maintenance network port 153 (step S213), and determines whether a LAN cable is connected to the maintenance network port 153 (step S215).

When the LAN cable is connected to the maintenance network port 153 (step S215: Yes route), the processing returns to step S213. On the other hand, when the LAN cable is not connected to the maintenance network port 153 (step S215: No route), the detection unit 102 notifies the controller 101 that the LAN cable is not connected to the maintenance network port 153.

The controller 101 outputs a third switching instruction to the first switch unit 103 and the second switch unit 104. In response to this, the first switch unit 103 breaks the transmission path connecting the management LAN controller 111 and the maintenance network port 153, and switches to a state in which each of the transmission paths is broken. Further, the second switch unit 104 connects the connection point 104a and the connection point 104c to connect the management LAN controller 111 and the controller 101 with a transmission path (step S217).

The controller 101 changes the network settings (the maintenance settings in this case) stored in the network settings storage unit 114 into the management LAN settings saved in the management LAN settings storage area in the data storage unit 106 (step S219). Specifically, the controller 101 transmits the management LAN settings saved in the management LAN settings storage area of the data storage unit 106 to the management controller 11. The management LAN controller 111 in the management controller 11 changes the network settings stored in the network settings storage unit 114 into the received management LAN settings. In step S219, the management LAN settings are transmitted via the transmission path connecting the controller 101 and the management LAN controller 111.

The controller 101 outputs a fourth switching instruction to the first switch unit 103 and the second switch unit 104. In response to this, the second switch unit 104 breaks the transmission path connecting the management LAN controller 111 and the controller 101 by connecting the connection point 104a and the connection point 104b. In addition, the first switch unit 103 connects the management LAN controller 111 and the management LAN port 152 with a transmission path by connecting the connection point 103a and the connection point 103b (step S221). Then, the processing ends.

By executing the aforementioned processing, not only the IP address and the subnet mask but also the MAC address is saved, and the security may be further enhanced.

### Embodiment 6

In the first to fifth embodiments, TCP/IP protocol is used, but Fibre Channel or InfiniBand may be used. In this case, instead of an IP address, a subnet mask, and a MAC address, a dynamic port address, a GUID (Globally Unique IDentifier) and a WWN (World Wide Name) may be used.

Although the embodiments of this invention were explained above, this invention is not limited to those. For example, the functional block configuration of the server 1 and the maintenance terminal 3, which are explained above, does not always correspond to actual program module configuration.

Moreover, the aforementioned data configuration is a mere example, and maybe changed. Furthermore, as for the processing flow, as long as the processing results do not change, the turns of the steps may be exchanged or the steps may be executed in parallel.

In addition, the aforementioned maintenance terminal 3 is a computer apparatus as illustrated in FIG. 25. That is, a memory 2501, a CPU 2503 (central processing unit), a HDD (hard disk drive) 2505, a display controller 2507 connected to a display device 2509, a drive device 2513 for a removable disk 2511, an input unit 2515, and a communication controller 2517 for connection with a network are connected through a bus 2519 as illustrated in FIG. 25. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform predetermined operations. Moreover, intermediate processing data is stored in the memory 2501, and if necessary, it is stored in the HDD 2505. In these embodiments of this invention, the application program to realize the aforementioned processing is stored in the computer-readable, non-transitory removable disk 2511 and distributed, and then it is installed into the HDD 2505 from the drive device 2513. It may be installed into the HDD 2505 via the network such as the Internet and the communication controller 2517. In the computer apparatus as stated above, the hardware such as the CPU 2503 and the memory 2501, the OS and the application programs systematically cooperate with each other, so that various functions as described above in details are realized.

The aforementioned embodiments of this invention may be summarized as follows.

An information processing apparatus related to a first aspect of these embodiments includes: a memory and a processor coupled to the memory. And the processor is configured to: (A) detect that a first apparatus is connected to a first network port; (B) change network settings of the information processing apparatus into first network settings for the first network port, upon detecting that the first apparatus is connected to the first network port; and (C) switch transmission paths in the information processing apparatus to enable the first apparatus to communicate using the first network port, upon detecting that the first apparatus is connected to the first network port.

In this way, communication with the first apparatus may be performed using the first network settings for the first network port, it enables a worker to carry out a maintenance work even if obtaining former network settings is limited.

Moreover, the changing may include (b1) saving the network settings before the changing to a storage area to which the first apparatus is not accessible. In this way, it becomes possible to enhance confidentiality of the network settings before the changing.

Moreover, the detecting may include (a1) detecting that the first apparatus is not connected to the first network port, the changing may include (b2) changing the network settings from the first network settings to second network settings that is former network settings upon detecting that the first apparatus is not connected to the first network port, and the switching may include (c1) switching the transmission paths in the information processing apparatus to enable to communicate using a second network port that is a former network port upon detecting that the first apparatus is not connected to the first network port. In this way, it becomes possible to return to a former state when a maintenance work is completed.

Moreover, the detecting may include (a2) detecting that the first apparatus is connected to the first network port when first identification data stored in a data storage unit matches second identification data received from the first apparatus. In this way, it becomes possible to prevent an apparatus that is not entitled to connect to the information processing apparatus from being connected to the information processing apparatus.

Moreover, the detecting may include (a3) updating the first identification data with third identification data that is different from the second identification data, when receiving the third identification data after the first apparatus is connected to the first network port. In this way, it becomes possible to improve security since using the same identification data continually is prevented.

Moreover, the processor may further be configured to (D) perform authentication based on information obtained from external hardware, the changing may include (b3) changing the network settings into the first network settings upon detecting that the first apparatus is connected to the first network port and a result of the authentication satisfies a predetermined condition, and the switching may include (c2) switching the transmission paths to enable the first apparatus to communicate using the first network port upon detecting that the first apparatus is connected to the first network port and the result of the authentication satisfies the predetermined condition. In this way, it becomes possible to improve security.

Moreover, the network settings may include at least one of an IP (Internet Protocol) address, a subnet mask and a MAC (Media Access Control) address.

Moreover, the network settings may include at least one of a WWN (World Wide Name), an address of a dynamic port and a GUID (Globally Unique IDentifier).

A maintenance system related to a second aspect of these embodiments includes: (E) an information processing apparatus; and (F) a first apparatus. And the first information processing apparatus includes: a memory and a processor coupled to use the memory. And the processor is configured to: detect that the first apparatus is connected to a first network port; change network settings of the information processing apparatus into first network settings for the first network port, upon detecting that the first apparatus is connected to the first network port; and switch transmission paths in the information processing apparatus to enable the first apparatus to communicate using the first network port, upon detecting that the first apparatus is connected to the first network port.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An information processing apparatus, comprising:
a memory; and
a processor coupled to the memory and configured to:
detect that a first apparatus is connected to a first network port;
change network settings of the information processing apparatus into first network settings for the first network port, upon detecting that the first apparatus is connected to the first network port; and
switch transmission paths in the information processing apparatus to enable the first apparatus to communicate using the first network port, upon detecting that the first apparatus is connected to the first network port.

2. The information processing apparatus as set forth in claim 1, wherein the changing comprises saving the network settings before the changing to a storage area to which the first apparatus is not accessible.

3. The information processing apparatus as set forth in claim 1, wherein the detecting comprises detecting that the first apparatus is not connected to the first network port, the changing comprises changing the network settings from the first network settings to second network settings that is former network settings upon detecting that the first apparatus is not connected to the first network port, and the switching comprises switching the transmission paths in the information processing apparatus to enable to communicate using a second network port that is a former network port upon detecting that the first apparatus is not connected to the first network port.

4. The information processing apparatus as set forth in claim 1, wherein the detecting comprises detecting that the first apparatus is connected to the first network port when first identification data stored in a data storage unit matches second identification data received from the first apparatus.

5. The information processing apparatus as set forth in claim 4, wherein the detecting comprises updating the first identification data with third identification data that is different from the second identification data, when receiving the third identification data after the first apparatus is connected to the first network port.

6. The information processing apparatus as set forth in claim 1, wherein the processor is further configured to perform authentication based on information obtained from external hardware, the changing comprises changing the network settings into the first network settings upon detecting that the first apparatus is connected to the first network port and a result of the authentication satisfies a predetermined condition, and the switching comprises switching the transmission paths to enable the first apparatus to communicate using the first network port upon detecting that the first apparatus is connected to the first network port and the result of the authentication satisfies the predetermined condition.

7. The information processing apparatus as set forth in claim 1, wherein the network settings include at least one of an IP (Internet Protocol) address, a subnet mask and a MAC (Media Access Control) address.

8. The information processing apparatus as set forth in claim 1, wherein the network settings include at least one of a WWN (World Wide Name), an address of a dynamic port and a GUID (Globally Unique IDentifier).

9. A network interface card, comprising:
a memory; and
a processor coupled to the memory and configured to:
detect that a first apparatus is connected to a first network port;
change network settings of an information processing apparatus into first network settings for the first network port, upon detecting that the first apparatus is connected to the first network port; and
switch transmission paths in the information processing apparatus to enable the first apparatus to communicate using the first network port, upon detecting that the first apparatus is connected to the first network port.

10. A maintenance system, comprising:
an information processing apparatus; and
a first apparatus,
wherein the first information processing apparatus comprises:
a memory; and
a processor coupled to use the memory and configured to:
detect that the first apparatus is connected to a first network port;
change network settings of the information processing apparatus into first network settings for the first network port, upon detecting that the first apparatus is connected to the first network port; and
switch transmission paths in the information processing apparatus to enable the first apparatus to communicate using the first network port, upon detecting that the first apparatus is connected to the first network port.
